(19) United States
(12) Patent Application Publication
(10) Pub. No.: US 2009/0271999 A1
(43) Pub. Date: Nov. 5, 2009

(54) Multi-function tape measure

(76) Inventor: Griffin C. Alker, Solana Beach, CA (US)

Correspondence Address: Morland C. Fischer;Suite 1300, 2030 Main Street, Irvine, CA, 92614, US

(21) Appl. No.: 12/151,122

(22) Filed: May 5, 2008

(51) Int. Cl. G01B 3/10

(52) U.S. Cl. 33/762; 33/761

(57) ABSTRACT

A compact, easy-to-carry multi-function tape measure to perform a variety of different jobs at home or in the field and ideally suited for use by carpenters, contractors, do-it-yourselfers, and the like. The tape measure includes a housing in which the usual pull-out measuring tape is carried. A retaining lip projects outwardly from the top of the housing. The housing has a graduated straight edge that is aligned perpendicular with the retaining lip. In use, the housing is laid on its side such that the outwardly projecting retaining lip overhangs and moves into interlocking engagement with a work surface to be cut. At the same time, the straight edge of the housing lies against the work surface to create a guide along which a marking instrument is moved for marking a cutting line on the work surface. The housing may also include the additional features of a graduated straight edge extension pivotally coupled to the straight edge, a recess for receiving a stack of peel-off note sheets on which messages are written, a finger grip, a removable scribe for marking the work surface with the cutting line, a slide-out protractor attached to and movable with the straight edge, a digital display, and a level.

### BACKGROUND OF THE INVENTION

1. Field of the Invention

This invention relates to a hand-operated, multi-function tape measure that is of compact size so as to be easily carried in a tool box, automotive glove compartment, or the pocket of a workman and adapted to perform a variety of jobs by carpenters, contractors, do-it-yourselfers, and the like.

2. Background Art

Tools have long been used to simplify jobs at work sites out in the field or around the home. Even simple jobs may require a variety of tools. In the event that different jobs are to be completed one after another, the workman may require access to a corresponding number of different tools. In some cases, the workman may forget to carry a particular tool that is needed for a particular job. In other cases, the workman may have to carry a relatively large and cumbersome box or bag in which an assortment of tools is transported from place to place. Accordingly, what would be desirable is a single, lightweight, multi-function tape measure that is easy to carry and capable of completing a variety of jobs at home and in the field including the ability to measure a distance so as to avoid the necessity of having to carry around many different tools to perform the same number of jobs.

### SUMMARY OF THE INVENTION

Briefly, and in general terms, a lightweight, hand-operated, multi-function tape measure is disclosed to be used by a workman to complete a variety of jobs at home or in the field in substitution of a number of different tools that is otherwise commonly required to complete the same number of jobs. The multi-function tape measure of this invention is adapted to easily fit within a toolbox, an automotive glove compartment, or a pocket of the workman. By virtue of its versatility, the multi-function tape measure herein disclosed is ideal for use by carpenters, contractors, do-it-yourselfers, and the like.

According to a preferred embodiment, the multi-function tape measure includes a plastic or metal housing with the usual pull-out tape available at the front of the housing for measuring distances. A belt clip is affixed at one side of the housing to permit the tape measure to be carried on the belt of a workman. A recess is formed in the opposite side of the housing in which to receive a stack of small, adhesive-backed note sheets on which messages and reminders can be written. A graduated straight edge having dimensions inscribed or marked thereon is located at the rear of the housing opposite the pull-out tape. A finger grip is formed along the bottom of the housing in which to receive the workman's fingers to enhance his grasp of the tape measure.

As an important feature of this invention, located at the top of the housing of the multi-function tape measure opposite the finger grip is a retaining lip. The retaining lip is preferably an integral part of the housing. Alternatively, the retaining lip may be an independent part that is connected (e.g., adhesively bonded) to the top of the housing. The retaining lip projects outwardly past one side of the housing so as to lie in perpendicular alignment with the straight edge. In operation, the housing is turned on its side such that the retaining lip overhangs a work surface to be cut. The workman may then use the graduated straight edge to mark off measurements or provide a guide for marking a cutting line across the width of the work surface. A folding, graduated straight edge extension can be pivotally coupled to the straight edge to increase the length thereof for use with wide work surfaces. When not in use, the folding straight edge extension is rotated relative to the straight edge so as to lie below the bottom of the housing. The straight edge may be fixedly connected to the rear of the housing or pivotally coupled thereto so as to be rotatable relative to the housing between at-rest and outstretched positions. An optional slide-out protractor may be connected to the straight edge. When the straight edge is in its at-rest position, the protractor is retracted inwardly of the housing. When the straight edge is rotated relative to the housing towards its outstretched position, the protractor is correspondingly pulled outwardly from the housing to be used in combination with the straight edge to enable a cutting line to be marked at a predetermined angle across the work surface.

The multi-function tape measure may also include one or more additional features to perform a variety of additional jobs. A pencil sharpener is accessible at one side of the housing so that a sharp pencil will be available for writing messages on the stack of note sheets or for marking cutting lines on the work surface. In case a writing instrument is not readily available, a scribe having a sharp tip is removably received within a channel through the housing. A digital display is visually accessible at the top of the housing to provide information such as time, date, etc. A level is carried at the bottom of the housing to provide a visual indication of the level of a surface on which the top of the housing is laid.

### BRIEF DESCRIPTION OF THE DRAWINGS

FIG. 1 is a perspective view showing the front, one side and top of a multi-function tape measure according to a preferred embodiment of the present invention;

FIG. 2 is a perspective view showing the rear, opposite side and top of the multi-function tape measure of FIG. 1;

FIG. 3 is a rear view of the multi-function tape measure of FIGS. 1 and 2;

FIG. 4 illustrates the use of the multi-function tape measure when laid on its side to establish a guide for marking a cutting line across the width of a work surface;

FIG. 5 illustrates certain optional features for the multi-function tape measure shown in FIGS. 1-4;

FIG. 6 illustrates additional optional features for the multi-function tape measure; and

FIG. 7 shows a retaining lip support from which a retaining lip projects being adhesively bonded to one side of the multi-function tape measure.

### DESCRIPTION OF THE PREFERRED EMBODIMENT

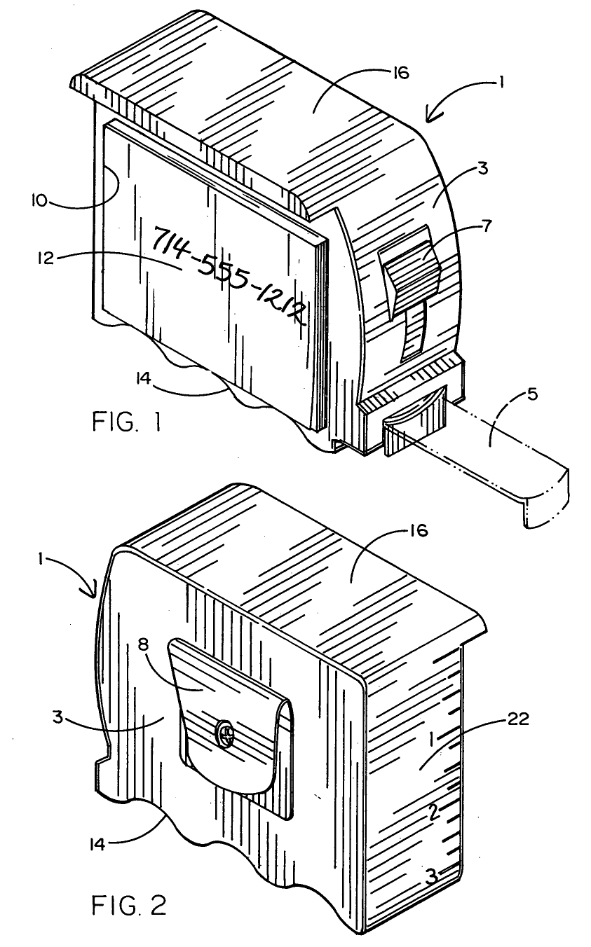

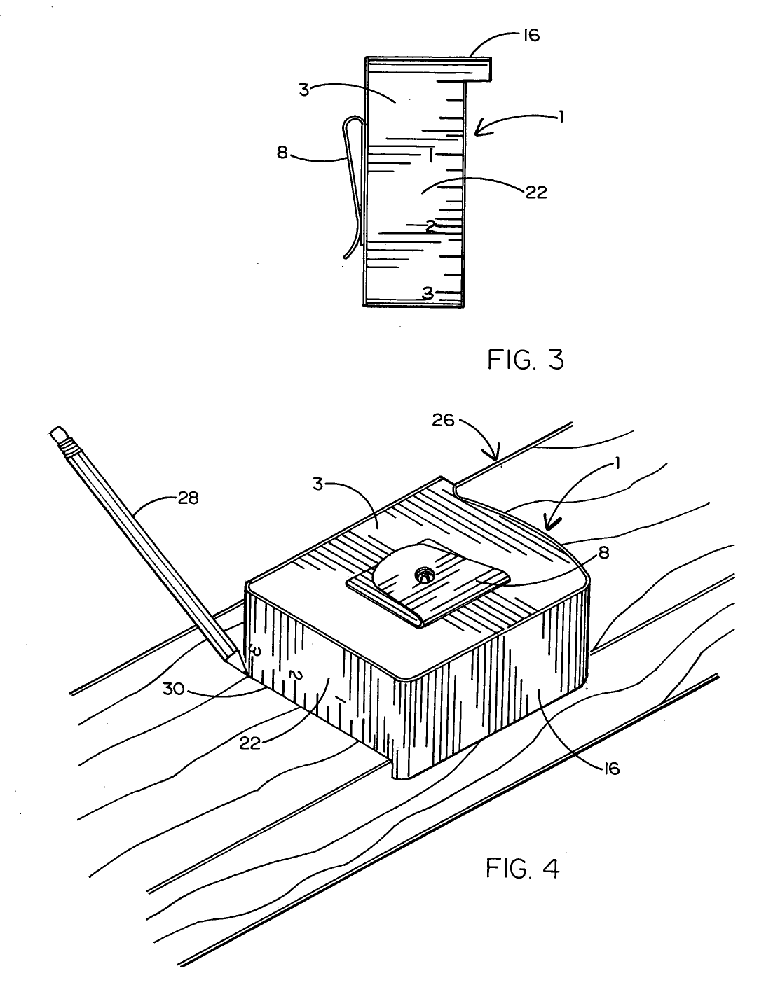

A preferred embodiment of the multi-function tape measure 1 which forms the present invention is described while referring concurrently to FIGS. 1-3 of the drawings. The tape measure 1 includes a housing that is typically manufactured from plastic or metal. As with conventional tape measures, the multi-function tape measure 1 includes a flexible, pull-out tape 5 that, (as shown in phantom lines) can be pulled from a rolled up position outwardly from the housing 3 in order to measure distances along a work surface. A standard lock release button 7 at the front of housing 3 can be actuated by a workman to cause the tape 5 to be automatically retracted inwardly of the housing once the measurement is completed.

A belt clip 8 is affixed to one side of the housing 3 to enable the tape measure 1 to be carried on the belt of the workman. A recess 10 is formed in the opposite side of the housing 3. The recess 10 is sized to receive therewithin a stack 12 of small, peel-off, adhesive-backed note sheets on which reminders and messages (e.g., telephone numbers, work specifications, measurements, etc.) can be written by the workman. Once used, the top most note sheet from the stack 12 is removed (i.e., peeled off) to expose a new note sheet on which to receive a new message. Once the stack 12 has been exhausted, a new stack having a fresh supply of note sheets may be located within the recess 10 in substitution of the prior stack.

The bottom of the housing 3 is formed (e.g., molded) to include a finger grip 14 running therealong. The finger grip 14 is sized to accommodate at least some of the fingers on one hand of the workman to enable the tape measure 1 to be more firmly and reliably grasped, particularly in damp or greasy work environments. As an important feature of the multi-function tape measure 1, and located at the top of the housing 3 opposite the finger grip 14, is a retaining lip 16. The retaining lip 16 projects from the top of housing 3 outwardly past one side thereof. The purpose of retaining lip 16 will be described in detail when referring hereinafter to FIG. 4 of the drawings.

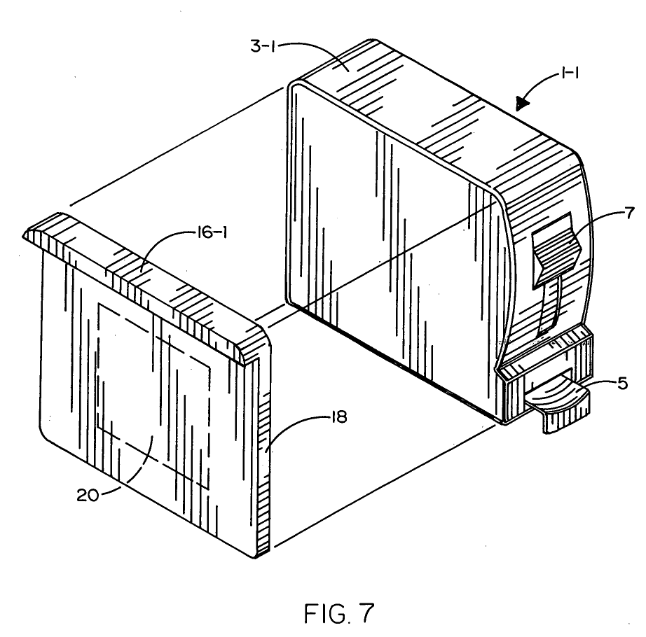

In the preferred embodiment shown in FIGS. 1-3, the housing 3 and the retaining lip 16 at the top thereof are integrally formed (e.g., molded) and coextensively connected to one another such that the multi-function tape measure 1 having finger grip 14 and retaining lip 16 is characterized by a one-piece construction. However, it is within the scope of this invention for the retaining lip 16 to be connected to the housing 3 in which case the retaining lip 16 is manufactured independently of housing 3. In this regard, and referring to FIG. 7 of the drawings, an optional stick-on retaining lip 16-1 is illustrated. The retaining lip 16-1 projects from and is aligned perpendicular with a lip support 18. Located at the inside of lip support 18 is a layer of adhesive 20 that is initially covered by a peel-off backing (not shown).

The lip support 18 is dimensioned to be mated in face-to-face engagement against one side of the housing 3-1 of multi-function tape measure 1-1. When it is desirable to attach the stick-on retaining lip 16-1 to the housing 3-1, the peel-off backing is removed and the lip support 18 is pressed against a side of the housing. The inside adhesive layer 20 bonds the lip support 18 to the tape measure 1-1, such that the retaining lip 16-1 is held adjacent the top of housing 3-1. In this case, however, the recess 10 of FIG. 1 in which to receive a stack 12 of peel-off note sheets is omitted from the housing 3-1 of tape measure 1-1. What is more, the lip support 18 can also be affixed to housing 3-1 by means of an epoxy or any other suitable bonding agent.

Returning briefly to FIGS. 1-3, the housing 3 of tape measure 1 is shown having a graduated straight edge 22 lying at the rear thereof opposite the pull-out tape 5 and locking release button 7. The straight edge 22 and the retaining lip 16 are disposed in perpendicular alignment with one another. The graduated straight edge 22 is inscribed or otherwise marked with dimension lines in the manner of a ruler to assist the workman in marking a work surface to be cut at a predetermined length. That is to say, and as is now explained while referring to FIG. 5 of the drawings, the retaining lip 16 at the top of housing 3 and the graduated straight edge 22 at the rear of the housing cooperate to enable the work surface to be marked and accurately cut to a desired size.

The work surface 26 shown in FIG. 5 is, for example, a commonly-known 2 by 4 or 2 by 6. The pull-out tape 5 (of FIG. 1) is first pulled from the housing 3 of multi-function tape measure 1 to enable the workman to measure a length to be cut off the work surface 26. Once the measured length is marked on the work surface 26, it may be necessary for the workman to make a straight and even cut.

To accomplish the foregoing, the tape measure 1 is laid on its side against the work surface 26, such that the retaining lip 16 overhangs one edge so as to lie in interlocking engagement therewith. At the same time, the graduated straight edge 22 runs laterally across the work surface 26. With the aid of a writing instrument 28, the workman uses the graduated straight edge 22 as a guide to draw a straight line 30 along which the work surface will be cut. Because the retaining lip 16 and straight edge 22 are disposed in perpendicular alignment, the cutting line 30 drawn with writing instrument 28 will be aligned parallel with respect to each end of the work surface and perpendicular with respect to the other faces.

Depending upon the width (or thickness) of the work surface and the corresponding length of the cutting line to be drawn thereacross, it may be necessary for the workman to also relocate the retaining lip 16 to the opposite edge of the work surface relative to that shown in FIG. 4. In any event, the cutting line 30 marked across the work surface 26 will be straight and true so that the work surface may be accurately cut as intended. What is more, the graduated straight edge 22 may also be used as a ruler to enable the workman to accurately mark off distances across the width (as shown) or thickness of the work surface depending upon the placement of the retaining lip 16.

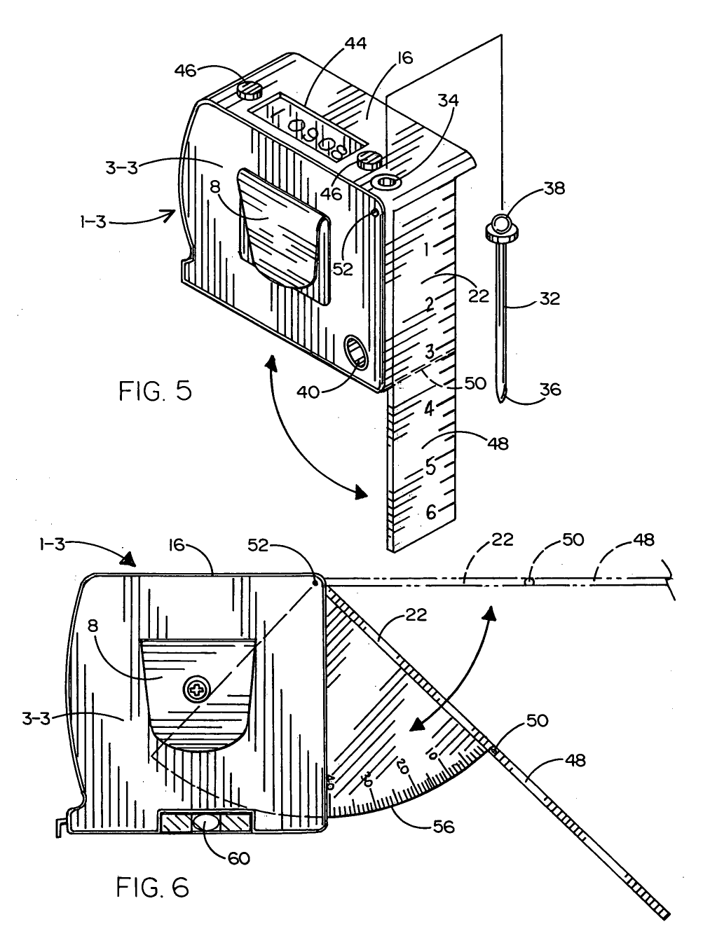

FIGS. 5 and 6 of the drawings illustrate optional features of the multi-function tape measure 1 of this invention. Turning first to FIG. 5, there is shown a scribe 32 to be carried by the multi-function tape measure 1-3 within a hollow channel 34 that runs through the housing 3-3. The scribe 32 has a sharp tip 36 at one end and a lifting ball 38 at the opposite end. The sharp tip 36 of scribe 32 can be used in substitution of a writing instrument (designated 28 in FIG. 4) to mark a cutting line in a work surface. The lifting ball 38 opposite the tip 36 can be grasped by the fingers of the workman when necessary to either move the scribe 32 from or return the scribe to its channel 34 in housing 3-3.

Should a pencil be used as the writing instrument to make the cutting line on the work surface, the multi-function tape measure 1-3 is conveniently provided with a pencil sharpener 40. The pencil sharpener 40 is accessible at one side of and located within housing 3-3 so as to avoid the retracted reel of pull-out tape 5.

A battery-powered digital display 44 is visually accessible through the retaining lip 16 at the top of the housing 3-3. One or more push buttons 46 are located adjacent the display 44 in order to control the operation thereof. As in conventional displays, the display 44 of the presently-described multi-function tape measure 1 is capable of providing readily available information to the workman (such as the time, date, etc.). Both the battery and the control electronics for display 44 are located inside the housing 3-3.

As was previously described while referring to FIGS. 1-4, a graduated straight edge 22 is located at the rear of the housing 3-3 of multi-function tape measure 1-3. The use of straight edge 22 as a guide for marking a cutting line or as a ruler (best shown in FIG. 4) is limited by the size of housing 3-3. In order to increase the length of straight edge 22 without increasing the size of the housing, a folding, graduated straight edge extension 48 (best shown in FIG. 5) is pivotally connected to the graduated straight edge 22.

The folding straight edge extension 48 is connected to straight edge 22 by means of a pivot pin 50, or the like, whereby the straight edge extension 48 is rotatable relative to the straight edge 22 through an arc of about 90 degrees between an axially-extended position (as shown in FIG. 5) to a folded position lying below the bottom of housing 3-3. Like the graduated straight edge 22, the folding straight edge extension 48 is preferably inscribed or marked with dimension lines. The straight edge extension 48 is rotated at pivot pin 50 to the axially-extended position to be aligned with straight edge 22 in order to establish a continuous guide for the writing instrument 28 (of FIG. 4) or scribe 32 (of FIG. 5) so that a relatively long cutting line can be marked on the work surface.

FIGS. 1-4 show the graduated straight edge 22 fixedly connected to the multi-function tape measure 1 along the rear of housing 3. However, FIGS. 5 and 6 show the graduated straight edge 22 rotatable relative to the housing 3-3 of tape measure 1-3. More particularly, one end of straight edge 22 is coupled to the rear of housing 3-3 by means of a pivot pin 52. As just explained, the opposite free end of straight edge 22 is coupled to the folding straight edge extension 48 by means of another pivot pin 50. Thus, the straight edge 22 and the extension 48 coupled thereto are rotatable relative to the housing 3-3 through an arc of about 90 degrees between an at-rest position (with straight edge 22 lying flush against the rear of housing 3-3 as shown in FIG. 5) and an outstretched position (shown in phantom lines in FIG. 6) with the axially-aligned straight edge 22 and extension 48 projecting in perpendicular alignment with the rear of housing 3-3.

In this case, a slide-out protractor 56 (best shown in FIG. 6) is attached to and movable with the graduated straight edge 22. When straight edge 22 is in its aforementioned at-rest position, the protractor 56 is retracted inwardly of the housing 3-3 of multi-function tape measure 1-3. When the straight edge 22 is rotated relative to the housing at pivot point 52 towards the outstretched position, the protractor 56 is correspondingly pulled outwardly from the housing 3-3. Accordingly, the straight edge 22, the straight edge extension 48 (if needed), and the protractor 56 all cooperate with one another to establish a guide and thereby enable a cutting line to be marked at a predetermined angle across the work surface. Any cutting angle up to 90 degrees may now be selected for marking on a cutting line across the work surface depending upon the position to which the straight edge 22 is rotated between the at-rest and outstretched positions.

Finally, the multi-function tape measure 1-3 may also be advantageously provided with a level 60 (best shown in FIG. 6). The level 60 is preferably located at the bottom of housing 3-3 so that the bubble of the level will be visually accessible to the workman. The bubble is responsive to the position of the top or bottom of the housing against a flat surface. In this case, the retaining lip 16 at the top of housing 3 (of FIG. 1) must be flat and parallel with the level 60 and/or the finger grip 14 at the bottom of the housing eliminated.

1. A multi-function tape measure comprising:
a housing, said housing having at least one straight edge;
a tape carried inwardly of said housing and having dimension lines printed thereon, said tape being pulled outwardly of said housing to take a measurement; and
a retaining lip projecting outwardly from said housing and sized to overhang and move into interlocking engagement with a work surface to be cut, the straight edge of said housing and said retaining lip aligned perpendicular with one another, and said straight edge lying against the work surface to create a guide along which a marking instrument is moved for marking a cutting line on the work surface.

2. The multi-function tape measure recited in claim 1, wherein said retaining lip is carried by a lip support to be connected to said housing so that said retaining lip projects outwardly from said housing.

3. The multi-function tape measure recited in claim 2, wherein said lip support includes an adhesive backing by which said lip support is adhesively bonded to said housing.

4. The multi-function tape measure recited in claim 1, wherein the straight edge of said housing has dimension lines printed thereon to enable said cutting line to be marked on the work surface to a predetermined length.

5. The multi-function tape measure recited in claim 1, further comprising a straight edge extension pivotally coupled to said straight edge, said straight edge extension being rotatable relative to said straight edge between a first position lying below the housing and a second position in axial alignment with said straight edge to increase the length thereof.

6. The multi-function tape measure recited in claim 1, wherein said straight edge is pivotally coupled to said housing, said straight edge being rotatable relative to said housing between a first position lying flush against said housing and a second position projecting outwardly from said housing.

7. The multi-function tape measure recited in claim 6, further comprising a slide-out protractor attached to said rotatable straight edge, said protractor sliding inwardly of said housing when said straight edge is rotated to said first position, and said straight edge sliding out of said housing when said straight edge is rotated towards said second position.

8. The multi-function tape measure recited in claim 1, further comprising a scribe having a sharp tip at one end thereof to move along said straight edge and thereby mark the work surface with said cutting line, said housing having a hollow channel running therethrough, and said scribe being removably received within said channel.

9. The multi-function tape measure recited in claim 1, further comprising a recess formed in said housing and at least one adhesive-backed writing surface on which notes can be written removably attached to said housing within said recess.

10. The multi-function tape measure recited in claim 1, wherein said housing has a finger grip formed therein in which to receive a workman's fingers to enhance the grip on said tape measure by the workman.

11. The multi-function tape measure recited in claim 1, further comprising a digital display carried by and visually accessible at said housing.

12. The multi-function tape measure recited in claim 1, further comprising a level carried by and visually accessible at said housing, said housing having a flat face extending in parallel alignment with said level.

13. A multi-function tool comprising:
a housing, said housing having at least one straight edge;
a straight edge extension pivotally coupled to said straight edge, said straight edge extension being rotatable relative to said straight edge between a first position lying adjacent the housing and a second position in axial alignment with said straight edge to increase the length thereof; and
a retaining lip projecting outwardly from said housing and being sized to overhang and move into interlocking engagement with a work surface to be cut, the straight edge of said housing and said retaining lip being aligned perpendicular with one another, and said straight edge lying against the work surface to create a guide along which a marking instrument is moved for marking a cutting line on the work surface.

14. The multi-function tool recited in claim 13, wherein each of said straight edge and said straight edge extension includes graduated dimension lines printed therealong.
